(19) United States
(12) Patent Application Publication
(10) Pub. No.: US 2013/0098840 A1
(43) Pub. Date: Apr. 25, 2013

(54) Porous Composite Media for Removing Phosphorus from Water

(71) Applicants: Richard Helferich, Clayton, OH (US); Ramachandra R. Revur, Hilliard, OH (US); Suvankar Sengupta, Hilliard, OH (US); J. Richard Schorr, Columbus, OH (US)

(72) Inventors: Richard Helferich, Clayton, OH (US); Ramachandra R. Revur, Hilliard, OH (US); Suvankar Sengupta, Hilliard, OH (US); J. Richard Schorr, Columbus, OH (US)

(73) Assignee: METAMATERIA TECHNOLOGIES, LLC, Columbus, OH (US)

(21) Appl. No.: 13/658,932

(22) Filed: Oct. 24, 2012

Related U.S. Application Data
(60) Provisional application No. 61/550,496, filed on Oct. 24, 2011.

(51) Int. Cl. B01J 20/16; B01J 20/32; C02F 1/28; C02F 101/10

(52) U.S. Cl. 210/670; 210/660; 502/439; 502/406; 502/407; 502/411

(57) ABSTRACT

Disclosed are nano-engineered porous ceramic composite filtration media for removal of phosphorous contaminates from wastewater and other water or liquid sources. Such porous ceramic media has high surface area and an interconnecting hierarchical pore structure containing nano-iron oxide/oxyhydroxide compounds, as well as other nano materials, surfactants, ligands or other compounds appropriate for removing higher amounts of phosphorous or phosphorous compounds. The composite media can be modified with nano-phased materials grown on the high surface area and addition of other compounds, contains hierarchical, interconnected porosity ranging from nanometer to millimeter in size that provides high permeability substrate especially suited for removal of contaminants at the interface of the water or other fluids and the nanomaterial or surfactants residing on the surfaces of the porous structure.

### CROSS-REFERENCE TO RELATED APPLICATIONS

This application claims benefit of provisional application 61/550,496, filed on Oct. 24, 2011, the disclosure of which is expressly incorporated herein by reference.

### STATEMENT REGARDING FEDERALLY SPONSORED RESEARCH

Not applicable.

### BACKGROUND

Phosphorus is a contaminant in streams and lakes that degrades water bodies. It comes into the environment in many ways but primarily from agriculture and waste treatment sources. In addition to ecological issues, phosphorous is principally derived from phosphate rock, a mined non-renewable resource found only in limited locations in the world. Over 80% of phosphorous is used for fertilizer, of which world agriculture is highly dependent. Better, low maintenance technologies are needed to reduce the buildup of Phosphorous in water bodies and to lower existing Phosphorous in these water bodies. Chemical methods can be used to remove Phosphorous at municipal wastewater treatment plants but these are not practical or cost-effective for smaller systems. While alternatives exist, these are generally less effective or cost-prohibitive and many do not sufficiently reduce

Phosphorous to regulated levels. Use of chemicals in water bodies can also create acidic conditions that are harmful to marine life.

Over 16,000 public waste treatment facilities operate in the United States and over 20% of all dwellings use on-site waste treatment systems (septic systems) to process wastewater. Some 48 billion gallons of wastewater is treated daily, typically containing over 5 ppm of Phosphorous. Some 207,355 miles of streams (about 31 percent) had “high” concentrations of Phosphorous while 108,029 miles of streams had “medium” concentrations. Over 2.5 million acres of lakes, reservoirs, and ponds are listed as impaired, which do not meet States' water quality goals. Point sources can include metal article manufacture, animal farms, on-site waste treatment systems, meatpacking effluent water and other food processing operations. Non-point sources of water pollution result when rainfall/storm water carries or collects pollutants across large surface areas, paved or non-paved, or that which drains from agricultural fields, eventually flowing into a water body from many random locations. Examples of non-point sources include:
Animal wastes, especially large livestock/swine/poultry operations
Septic or on-site waste treatment
Agricultural runoff from commercial fertilizer
Developed land runoff

A growing need exists for better and more efficient water treatment systems for removal of Phosphorous compounds, such as phosphates, from water, especially approaches that are effective for use with small to medium size on-site wastewater systems and for water found in recirculating systems such as used for aquaculture, wastewater discharge from wastewater treatment plants or industrial and agricultural applications that need to limit discharge of Phosphorous. Such media is also needed to effectively remove Phosphorous found at lower concentration levels in water bodies, such as lakes, streams, estuaries and the like or collected from storm water or from agricultural runoff. While it may become obvious throughout the descriptions and examples provided in this patent disclosure that other types of Phosphorous and other contaminants can be reduced through the use of this unique porous composite media, only the control of Phosphorous is considered.

An ability to recover Phosphorous from saturated media will have considerable economic value if media can be reused after the Phosphorous is removed and the Phosphorous, which is a valuable commodity, can be economically reclaimed.

Phosphorous can occur in many forms, such as phosphate compounds, that are frequently present in all forms of wastewater and in many water sources, whether industrial, municipal, agricultural or aquaculture applications. Phosphorous is an important biological nutrient found in all living matter, ranging from bacterial colonies, to plants and algae, and all living animals and Phosphorous is widely used in most food products, in fertilizer, in corrosion control, and in many industrial products. Phosphorous compounds can enter water in any number ways described earlier, but mainly it is through the decomposition of food and nutrient waste (sewage effluent and runoff from land where manure is applied or stored). While Phosphorous is considered a plant nutrient, higher concentrations in water bodies, such as lakes and streams (greater than about 0.2 mg/L [as PO₄⁻P]) can cause excessive growth of algae leading to accelerated eutrophication of these water bodies and contamination with toxic compounds.

While a number of Phosphorous absorbent media are available (typically iron and aluminum based materials, e.g., iron oxides and activated alumina) these materials generally do not sorb sufficiently high quantities of Phosphorous, so a need exists for better, more efficient, cost effective sorbent materials for removal of Phosphorous. Systems requiring Phosphorous control include on-site treatment of industrial or domestic wastewater, municipal wastewater, water from industrial and food processing operations, agriculture or aquaculture production and storm water runoff. Excess Phosphorous compounds contribute significantly to eutrophication in many inland and coastal ecosystems. For example, a common approach in maintaining low Phosphorous levels in aquaculture systems is through water replacement (changes) in both fresh and marine aquaculture systems. While viable to maintain a healthy aquaculture environment, the discharge of the wastewater into the ecosystem is still a major problem and represents a cost that can be avoided if replacement is not necessary.

Various alumina or iron containing media has been studied for capturing Phosphorous, ranging from natural iron oxide to highly manufactured products. Media to remove Phosphorous typically contains iron oxides, zero valent iron, and/or aluminum oxides, but can also contain lanthanum and calcium, which are known to have an affinity for Phosphorous compounds. Waste products have been thoroughly examined. Media selectivity and effectiveness can depend upon other ions that are present, pH, dissolved oxygen levels, contact time, and the relative concentrations of the constituents. Specific studies have been reported in the literature that compare various natural and manufactured media, including those based on limestone, furnace slag, iron filings, activated aluminum, and iron-coated materials. Natural soils are found⁽¹⁾ to sorb less than 0.5 mg P/gr (mg of Phosphorous per gram of media), natural iron containing materials absorb 2-3 mg P/gr, and iron activated alumina absorbs 16 mg P/gr.

Most, if not all, wastewater represents complex mixtures of many contaminate and nutrient compounds. As is described below, by providing a porous media with a vast, interconnected pore structure having high available surface area provided by nanocrystals, multiple active sites can be designed into the composite structure of the media. Because of the available high surface area and active sites developed, the capacity and ability of the media to rapidly remove Phosphorous compounds is greatly increased.

Therefore, this disclosure utilizes a highly porous inorganic composite media that is not subject to clogging or rapid deterioration, while maintaining the required water alkalinity and pH and having a much higher Phosphorous adsorption rate than any other media.

### BRIEF SUMMARY

Most, if not all, wastewater represents complex mixtures of many contaminate and nutrient compounds. As is described below, by providing a porous media with a vast, interconnected pore structure having high available surface area provided by nanocrystals, multiple active sites can be designed into the composite structure of the media. Because of the available high surface area and active sites developed, the capacity and ability of the media to rapidly remove Phosphorous compounds is greatly increased.

### BRIEF DESCRIPTION OF THE DRAWINGS

For a fuller understanding of the nature and advantages of the present media and process, reference should be had to the following detailed description taken in connection with the accompanying drawings, in which:

FIG. 1A is a photomicrograph of a porous ceramic with hierarchical pore structure;

FIG. 1B is a photomicrograph of the porous ceramic of FIG. 1A with the surfaces covered with 20-100 nm nanofibers;

FIG. 2 graphically plots Phosphorous removal capacity of media per unit volume versus log P, as reported in Examples 5, 6, and 7;

FIG. 3 graphically plots Phosphorous removal capacity of media per unit volume for different media, as reported in Example 8;

FIG. 4 graphically plots Phosphorous removal capacity of media per unit volume as a function of the concentration of added Ca, as reported in Example 9;

FIG. 5 is the schematic of the column testing equipment used in Example 10′

FIG. 6 graphically plots the Phosphorous concentration for the influent and effluent bed volumes, as reported in Example 10;

FIG. 7 graphically plots the Phosphorous concentration for the influent and effluent bed volumes at a different flow rate, as reported in Example 10;

FIG. 8 graphically plots the Phosphorous concentration for the influent and effluent bed volumes over the course of 120 days, as reported in Example 10;

FIG. 9 graphically plots the Phosphorous concentration removal as a function of regeneration cycles, as reported in Example 11;

FIG. 10 graphically plots the percent of sorbed Phosphorous removed by the sodium hydroxide from media as a soluble (sodium phosphate) ion, as reported in Example 11; and

FIG. 11 graphically plots the Phosphorous concentration in the influent and effluent versus bed volumes, as reported in Example 12.

The drawings will be described in greater detail below.

### DETAILED DESCRIPTION

This disclosure relates to sorption media with hierarchical porosity functionalized with nanomaterials and/or organic ligands (surfactants) engineered for removal of Phosphorous compounds from contaminated water. A chemical treatment can be used to remove Phosphorous from saturated media, which can then be recovered (e.g. as calcium phosphate) for use as a Phosphorous source for fertilizer, food or other applications. The media can be chemically regenerated using a mild acid treatment. It can be used repeatedly for harvesting Phosphorus from water. Because the cost for regenerating media is much lower than required to make the original media, the life cycle cost of media is lowered considerably, to less than 50% of the initial cost.

As described earlier, preparation of the unique, -Phosphorous absorbing composite media begins by forming a porous substrate with interconnecting pores and a high surface area that can be modified with unique nano-sized crystalline or amorphous materials. These may include iron based compounds, as well as La and Ca and Mg compounds that have been shown to increase the capacity of media for sorbing Phosphorous. The composition of the porous substrate can be adjusted by adding compounds, such as iron powders, that enhance Phosphorous removal. These aggregates are bonded together in the porous matrix with alumino-silicate geopolymeric compounds, usually added as liquids (at least one of the components) and contain raw materials such as alkali (Na, K, Li etc) silicates and aluminates that can be used to chemically form an alumino-silicate geopolymer bond. If needed, pressure may be used during the forming process to develop a porous structure of the desired density.

One of the preferred approaches to form the porous ceramic body is described. In order to create a porous composite substrate with an interconnected pore structure hierarchy, a novel hydrogel or geopolymer bonding process and a foaming process can be used. Typically, two slurries are prepared; one containing a soluble silica source, such as sodium silicate, plus reactive silica compounds (such as, silica fume, metakaolin, or the like), an iron based powdered aggregate (such as, ground cast iron filings, cast steel powders or mixed valent iron oxide compounds), specialty surfactants (such as a high-efficiency silicone glycol copolymer), and a gas producing agent; while the second slurry contains a source of soluble alumina, such as sodium aluminate, plus reactive silica compounds (such as, silica fume, metakaolin and the like), an iron based powdered aggregate (such as, ground cast iron filings, cast steel powders or mixed valent iron oxide compounds), and the same specialty silicone glycol copolymer surfactants. Other minerals or compounds, such as La and Ca compounds, may be added as enhancing additives to these slurries to impart better absorbent properties. These slurries are typically cooled to room temperature (or below) to control the rate of reaction between components when mixed together. The two slurries are combined in a controlled manner to prepare a uniform dispersion of all the ingredients. The specific weight ratio of soluble silica to soluble alumina can be varied to change the processing conditions and the product properties. The combined slurry then is placed into molds by casting or by injection into a mold of a desired monolithic shape or pelletized into various sizes or cast as continuous sheet that will be cut or broken into smaller pieces or aggregates. Once the liquids are combined, the reactive gassing agent, in combination with the specialty surfactants, produces sufficient gas to create (a foam) that establishes the desired interconnected pore structure. The amount and type of the remaining materials in addition to the total amount of gassing agent controls the final density of the media. Chemical reactions between the silica and alumina rich liquids occur to solidify the material, typically within 10 to 30 minutes, depending upon the composition and processing conditions.

TABLE I
Relative Composition of the Combined
Ingredients for Porous Ceramic Base

| Ingredient | Amount (wt-%) |
|---|---|
| Sodium Silicate | 2-10 |
| Sodium Aluminate | 2-10 |
| Water | 10-15 |
| Total Surfactants | 0.1-2 |
| Reactive Alumina-Silica Compounds | 5-30 |
| Iron Base Constituents | 5-70 |
| Enhancing Constituents | 0-10 |
| Gassing Agents | 0.02-1.0 |

Following solidification of the foamed material, the porous composite is cured and dried under controlled temperature and humidity conditions. Excess alkali may be leached with water or removed by ion exchange methods.

To produce the final media, the porous substrate then is modified with nanomaterials and/or surfactants to obtain the desired characteristics needed for high Phosphorous sorption. Once the porous substrate is prepared, different methods for the growth of nano-materials onto the iron-based porous substrates may be used. Alternatively, nanomaterials can also be grown on the surface of other porous materials, such as metakaolin, naturally occurring zeolites or treated fibers.

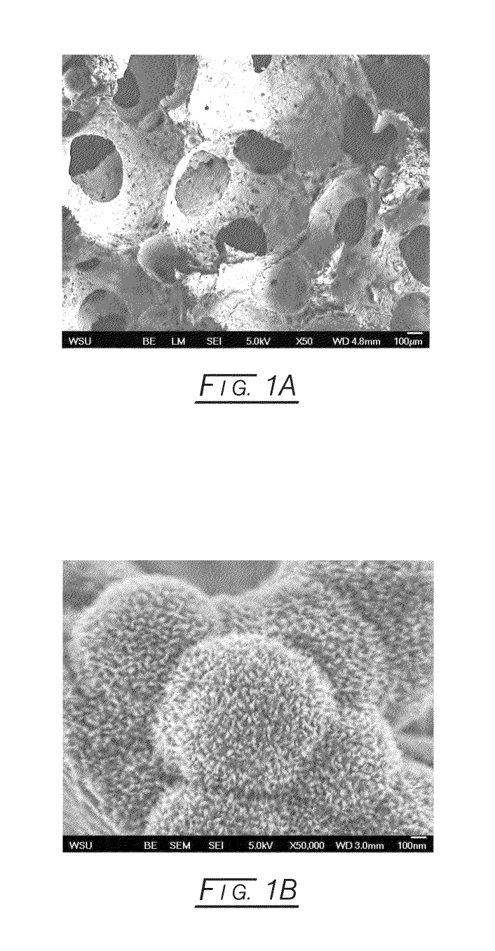

One of the nanomaterials grown on the porous substrate is an iron compound, such as an oxyhydroxide or oxide compound. These nanomaterials significantly increase the surface area of the media (typically increasing from 15 m²/gram to over 70 m²/gram, which creates an active layer for the sorption of Phosphorous compounds. The microstructure of these nanomaterials is seen in FIG. 1.

Other nanoparticles have been shown to contribute to Phosphorous removal and these also may be grown (such as lanthanum, calcium, zirconium, and magnesium compounds) or these can also be added as enhancements in the porous ceramic composition base material. Nanomaterials also may be grown or deposited to enhance the functionality of the media, such as antimicrobial material to inhibit bacteria growth.

Two methods were used successfully to grow iron-based nanoparticles: one is a precipitation-deposition method, while another is an oxidative-deposition method. Either of these methods produces a significant amount of nano-iron materials on the pore surfaces of the composite material. The oxidative-deposition method is preferred because less waste is produced and the cost of the chemicals used is lower. The process can be used to grow nanomaterials on any porous body like those described earlier or other naturally occurring porous materials and fibers. The size of the nanomaterials grown on the media typically will range up to about 700 nm in size and can be particulate, monolithic, or virtually of any other geometry.

In use, Phosphorous compounds will be sorbed until the media is saturated. When this occurs, the media can be replaced and the Phosphorous chemically removed (typically using a base) and the media regenerated (using a mild acid) and then reused. If required, additional nano-iron compounds and surfactants can be added during regeneration. Regeneration of the media is desirable, since it reduces the life cycle cost of the media and the soluble Phosphorous removed can be recovered and sold, thus harvesting an important element needed for food products and agricultural uses.

It has been determined that the initial capacity of the media is generally maintained after Phosphorous removal and regeneration. Phosphorus is extracted from the saturated media with an alkali base, such as sodium hydroxide. Chemical regeneration is typically done using a mild acid, such as citric acid. After regeneration, the capacity of the media remains near to its original measured capacity. Extracted soluble Phosphorous (typically over 95%) can be removed from the alkali mixture by adding chemicals that form a precipitate. For example, if a calcium source is used, calcium phosphate can be precipitated and this can be collected and sold as a resource for making Phosphorous containing materials.

Testing has shown that the media can be regenerated at least six times while maintaining an absorption capacity above 85% of the original capacity. Increases in capacity also were found after some regeneration cycles, which are believed due to activation during regeneration of some of the iron powder used in the base media, adding some additional capacity. The base iron media itself, without nano modification, shows a Phosphorous capacity of 15 to 20 mg P/gr, which is about 20% of the capacity of the nano-enhanced media.

The cost for regeneration is estimated to be much lower than the cost to make the original media. This can significantly reduce the life-cycle costs of the media and make it more economically attractive for many applications, including replacement of chemical treatment often used to remove Phosphorous from wastewater and to lower the amount of Phosphorous in lakes, streams and other water bodies where restoration is needed because of excess algae growth. Even at lower Phosphorous concentrations (1 ppm), regenerated media can be economically feasible, compared with chemical methods (e.g., Alum Treatment) or more expensive absorptive media. Removal of Phosphorous from storm water and agricultural runoff is also expected to be economically feasible.

The following examples show how the product and process disclosed herein has been practiced, but they should not be construed as limitative thereof.

### EXAMPLE 1

### Preparation of Porous Substrate

To prepare porous ceramic substrates, two slurries are prepared; one containing a soluble silica source such as, sodium silicate, plus reactive silica compounds (e.g., silica fume, metakaolin, and the like), iron powder was used as an aggregate, silicone glycol copolymer surfactants and gas producing agents; while the second slurry contains a source of soluble alumina such as sodium aluminate, plus reactive silica compounds (e.g., silica fume, metakaolin, and the like), iron powders as an aggregate, and silicone glycol surfactants. Each of the two slurries was cooled to below room temperature (<20° C.) and then equal amounts of the two slurries were combined and prepared into a desired shape, using molds or pelletizing equipment. The combined slurry foams (expands) and will set into a hard product within 10-30 minutes. The blend of the two slurries can be molded in the presence of metal or polymeric reinforcement, such as, for example wires or rods.

Aggregate is prepared either by crushing and screening a thinner sheet of material or by using a pelletizer or other equipment that allows for the formation of small aggregates. Monoliths are formed by pouring or injecting the combined slurries into a mold of the desired shape and size. Once hardened, the material is cured in a humidity-controlled environment (typically at 60° C. and 60% relative humidity) until desired properties are obtained. Once cured, the material can be dried (to less than 15% moisture) or leached with water to remove any excess alkali and then rinsed with a mild acid (such as citric acid) to oxidize the iron surfaces to a mixed oxide surface (such as, FeOOH). The surface area of this media is ˜10-20 m²/gram (as measured using the BET method). While this porous, iron-based media can be used directly for the removal of Phosphorous, for higher performance modification with nano materials and/or surfactants is required. Batch tests conducted with the porous iron-based material shows removal of ˜19 mg of Phosphorous per gram of media at a concentration of 10 mg/L, which is equivalent to iron activated alumina used commercially for Phosphorous removal.

### EXAMPLE 2

### First Method for Nano-Modification

The media of Example 1 is modified by soaking the media first in a base solution, such as TMAOH (tetramethyl ammonium hydroxide), until saturated and then media is removed and soaked in an iron precursor solution. This method was optimized by varying different parameters such as, soaking time, concentration and type of chemicals, such as iron nitrate or iron sulfate. After modification is completed, media is dried. The surface area of the media after nano material deposition is typically in the range of 50-65 m²/g. Media made using this method has an increased rate of Phosphorous removal (using a standard 24 hour batch test) of 50-55 mg of Phosphorous per gram of media at a concentration of 10 mg/L Phosphorous in the water.

### EXAMPLE 3

### Second Method for Nano-Modification

The media of Example 1 is first treated with an oxidizing agent such as, potassium permanganate for 2-3 hours and then exposed to an iron precursor solution, in order to form iron oxyhydroxide or iron oxide by oxidation and deposition or growth of these nanomaterials onto the surface of the base porous media. After the modification is completed, the media is dried. The addition of nano-materials using this method increases the surface area of the media by the addition of this active layer for Phosphorous absorption. After one treatment cycle, the surface area increased from ˜15 m²/gram to 55 m²/gram (BET method) and after a second treatment cycle, surface area increased to over 70 m²/g. Chemical analysis (ICP-inductively coupled plasma spectroscopy) of the modified media was used to estimate the amount of nano-iron added to the porous media. Tests on multiple samples showed between 8 and 10% of nano-iron (expressed as FeOOH) was added. Phosphorous removal (using a standard 24 hour batch test) for this media increased to more than 70 mg of Phosphorous per gram of media and some tests show more than 100 mg/gram at higher concentrations of Phosphorous in the water.

### EXAMPLE 4

### Surfactant Enhancement

The media of Example 3 was further modified by the addition of a surfactant treatment using HDTMABr. As evidence of the surfactant treatment, the surface area by the BET method decreased slightly from 60-70 m²/g range to 50-60 m²/g, indicating that the surfactant treatment occupied or closed some the pores responsible for the higher surface area. Media made in this fashion had a slightly increased rate (10%) of Phosphorous removal (24 hour standard batch test) compared to the same media without surfactant modification, indicating that surfactants can be used to obtain additional increases in Phosphorous absorption.

### EXAMPLE 5

### Performance of Phosphorous Removal at 1 mg/L

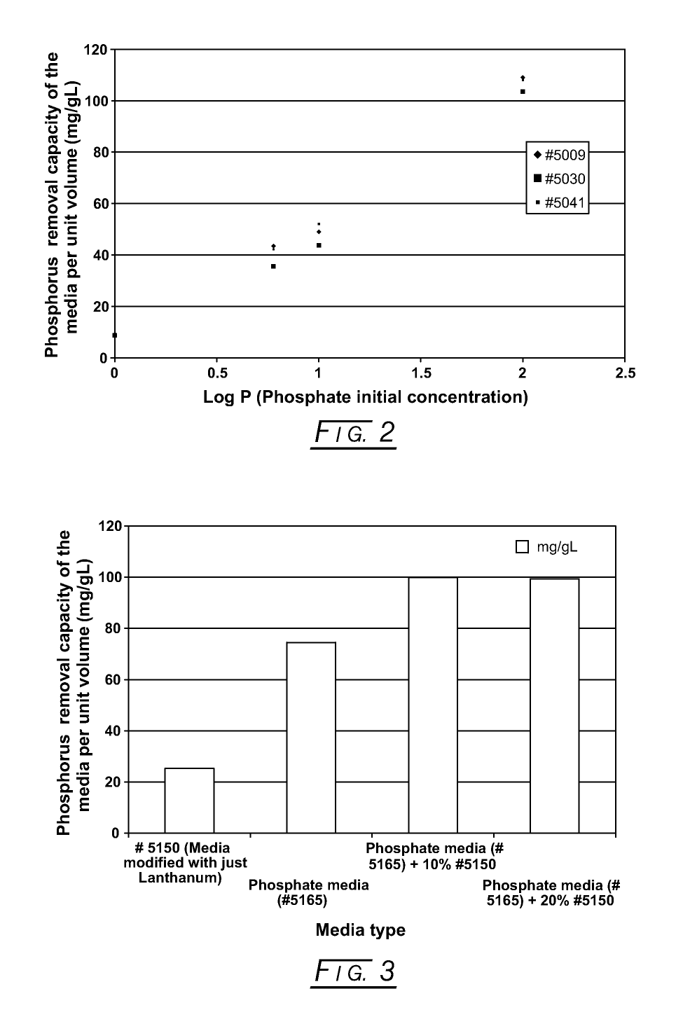

The media of Example 3 was also tested for removal of Phosphorous at a lower concentration of 1 mg/L Phosphorous in the water. The standard 24-hour batch test was used and all the parameters were kept the same. This test (Sample 5009) showed a lower Phosphorous removal capacity of Phosphorous sorbed of over 25 mg per gram of media (FIG. 2).

### EXAMPLE 6

### Performance of Phosphorous Removal at 20 mg/L

The media of Example 3 was also tested (24 hour standard batch test) for Phosphorous removal at an initial Phosphorous concentration was 20 mg/L. All the parameters of the batch test remained the same. Phosphorous sorbed was over 75 mg of Phosphorous removed per gram of media (Sample 5030), as seen in FIG. 2.

### EXAMPLE 7

### Performance of Phosphorous Removal at 1000 mg/L

The media of Example 3 was also tested (24 hour standard batch test) for Phosphorous removal at an initial concentration of 1000 mg/L. All batch test parameters were kept the same. Phosphorous sorbed was over 100 mg of Phosphorous per gram of media (Sample 5041), as seen in FIG. 2.

### EXAMPLE 8

### Effect of Lanthanum on Phosphorous Removal

The media of Example 3 also was tested for Phosphorous removal in the presence of lanthanum. All the standard batch test parameters were kept the same. The lanthanum source can be added either to the synthetic water or incorporated into the porous media during modification of the media. Phosphorous removal (24 hour standard batch test) showed removal of 100 mg of Phosphorous per gram of media.

After confirming lanthanum addition will help in the removal of Phosphorous, the porous substrate was modified by growing lanthanum hydroxide nanoparticles. The procedure for adding the lanthanum hydroxide nanoparticles involved recirculating a base solution such as TMAOH (tetramethyl ammonium hydroxide) over the media for a few hours and then recirculating a 2% lanthanum precursor solution such as lanthanum nitrate for couple of hours, followed by a wash with water to remove any excess ions. Media (Sample 5150) was dried in an oven and tested for removal of Phosphorous in the standard 24-hour batch test. The media without any iron oxide nanoparticles (Sample 5165) also shows removal Phosphorous, as seen in FIG. 3. Additional experiments using this lanthanum modified media as an additive to media described in Example 3 was done and these results are shown in FIG. 3. It is clear that a 10% addition of lanthanum-modified media increases the Phosphorous sorption capacity by 30%, with no further increase at higher amounts.

### EXAMPLE 9

### Effect of Calcium on Phosphorous Removal

The media of Example 3 was also tested for Phosphorous removal in the presence of calcium, since it is reported that minerals containing calcium remove Phosphorous, although capacities reported are low. All standard test parameters were kept the same. A calcium source can be added (1) to the synthetic water or (2) added as an enhancement to the base porous composite or (3) incorporated during nano-modification of the media.

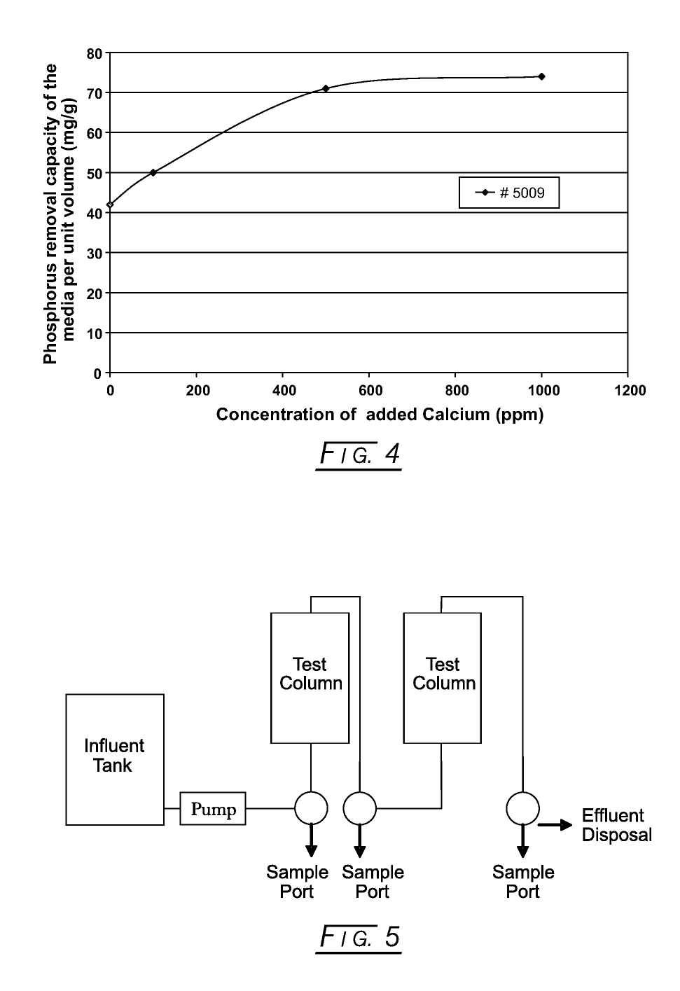

Additions of calcium chloride (0 ppm, 50 ppm, 100 ppm, 500 ppm, and 1000 ppm) were made to the synthetic water and Phosphorous sorption was measured (using 24 hour standard batch test). The capacity to sorb Phosphorous increased with increasing additions of calcium up to 500 ppm (FIG. 4), where the capacity stabilizes over 40% higher than with no calcium. Testing at 100-ppm calcium also shows that sorption also increases with contact time, continuing to increase up to 100 hours of contact time.

### EXAMPLE 10

### Column Testing of Phosphorous Media

Granular media from Example 3 was tested in a 600 ml column filled with a 150 ml of granular media, a schematic of which is shown in FIG. 5. Synthetic wastewater (Table II) containing Phosphorous was passed through a column of media at a controlled flow rate in order to measure removal at different empty bed contact times (EBCT).

TABLE II
Phosphorous Reduction Performance in Synthetic Wastewater

| | Influent | Effluent | | P Removal |
|---|---|---|---|---|
| Water Parameter | (mg/L) | (mg/L) | After BV | (mg P/g) |
| PO₄—P (mg/L) | 6-7 | <1 | 950 | >15 |
| SiO2 (mg/L) | 20 | 25 | | |
| pH | 8.03 | 7.93 | | |

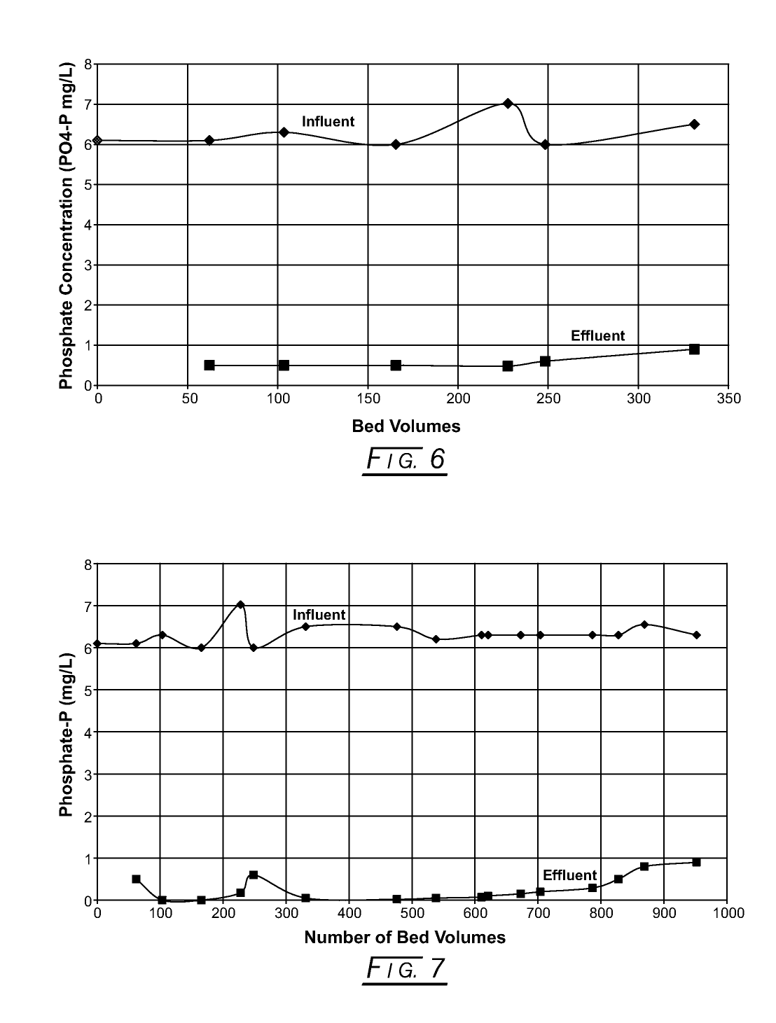

The effluent water was collected after passing through the media and measured to determine the amount of Phosphorous removed by the media (FIG. 6). Synthetic wastewater was prepared using sodium phosphate and buffering agents to create a concentration of 6-7 mg/liter of Phosphorous [PO₄⁻P] at a neutral pH (7-8). The initial flow through the column was 15 minutes (EBCT). A drop in the influent Phosphorous occurred from an average of 6.5 mg/L to less than 1 mg/L [PO₄—P] and remained less than 1 mg/L [PO₄—P] for over 350 Bed Volumes (BV). The flow was lowered to obtain a 30-minute EBCT experiment and the results are shown in FIG. 7 where the concentration of Phosphorous remained below 1 mg/L for over 950 BV.

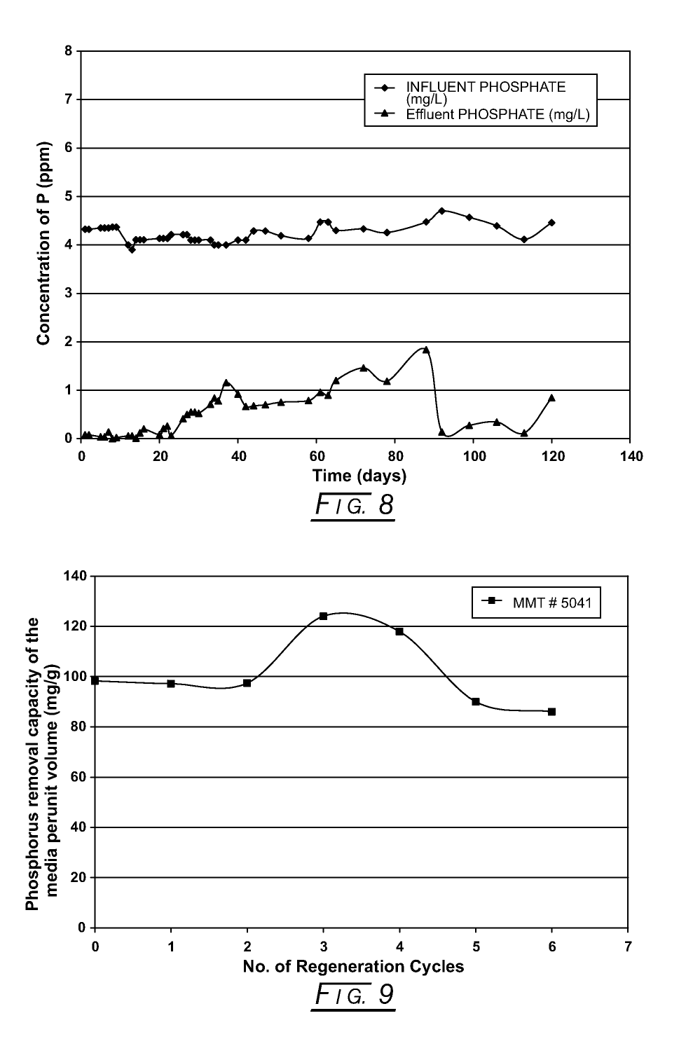

Testing was also conducted using porous monoliths, prepared using the methods described in Example 1. Disks were prepared having a 1.85-inch diameter and 1-inch thickness. These were then modified using procedures described in Example 3 to obtain iron oxyhydroxide/iron oxide nanoparticles. Columns containing 4 discs were prepared and connected in series (FIG. 5). Synthetic wastewater containing Phosphorous was passed through the columns a controlled flow rate in order to obtain a desired empty bed contact times (EBCT), such as 30 minutes or 60 minutes. The effluent water was collected after passing through the media and measured to determine the amount of Phosphorous removed by the media. Results are shown in FIG. 8. Phosphorus remains below 1 ppm in the effluent water even after 120 days of continuous testing.

### EXAMPLE 11

### Media Regeneration

Regeneration of media containing Phosphorous is desirable and can have an important impact on reducing the life cycle cost of the media and recovered Phosphorous can likely be sold and waste is reduced. Media used in Example 3 (Sample 5041) was examined for Phosphorous removal and regeneration for reuse. For these tests, media was saturated with Phosphorous by exposing it at a concentration (1000 mg/L). The standard 24-hour batch test was used to measure the Phosphorous sorption capacity. Phosphorous was removed from the saturated media as a soluble ion by washing with an alkali (in this example sodium hydroxide but other bases (e.g., potassium hydroxide) could also be used to extract Phosphorous from the media. After the Phosphorous was removed, the media was regenerated by adjusting the pH of the media using a mild acetic acid. This was considered to be a single regeneration cycle. Experiments with the same media were continued for five more regeneration cycles and results are shown in FIG. 9. Capacity to sorb Phosphorous was not significantly changed for up to six regeneration cycles. Phosphorous removal was around 100 mg per gram of media for each regeneration cycle, representing removal of over 600 grams of Phosphorous. As explained previously, a slight increase in capacity was believed to be due to activation of iron particles contained in the porous base composition.

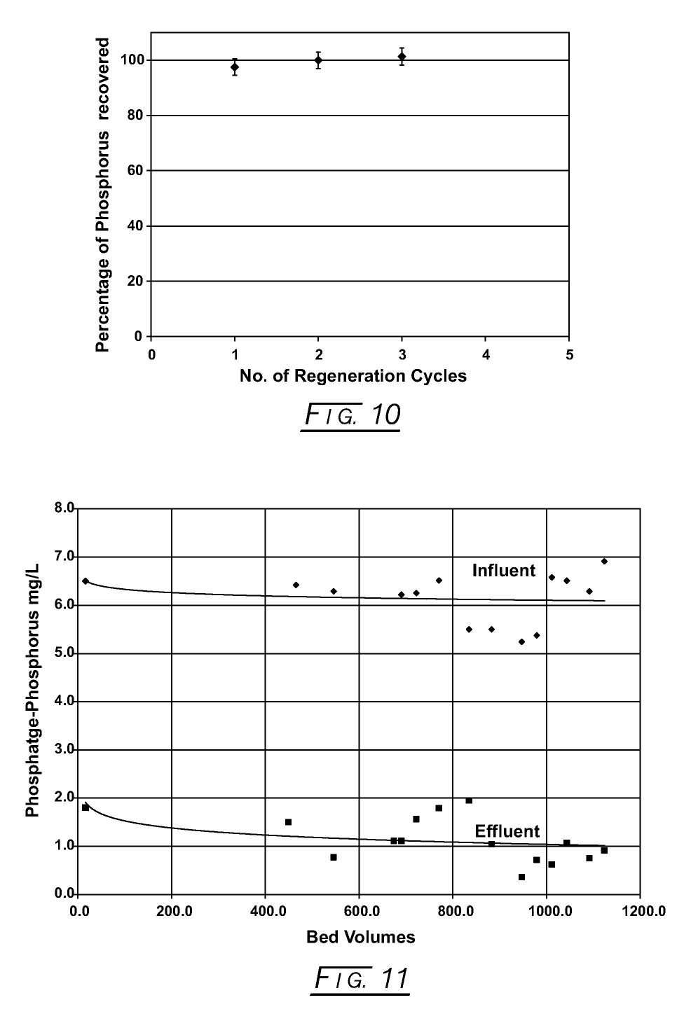

Almost all of the sorbed Phosphorous was successfully removed from the media in this example. FIG. 10 shows the percent of sorbed Phosphorous removed by the sodium hydroxide from media as a soluble (sodium phosphate) ion.

In order to recover the Phosphorous, calcium ions were used to precipitate calcium phosphate, which was then recovered by filtration. The surface area of the Ca₃PO₄ powder was 188 m²/g, which shows that it consists of fine crystallites. ICP measurements confirmed that the correct ration of Ca to P existed and purity was high. This demonstrated that Phosphorous recovery is feasible.

### EXAMPLE 12

### Waste Water Testing

The media from Example 3 was evaluated in a column test in which water from an actual septic tank discharge was used. As done with synthetic wastewater, the flow passed upward through the bed of media in a controlled manner at a fixed EBCT. This actual septic tank discharge water contained 6-7 mg/L of Phosphorous [PO₄—P] as well as some calcium ions (38 mg/L), silica (19 mg/L), iron (2 mg/L), magnesium (12 mg/L), manganese (0.2 mg/L), organics, such as as TBODS (23 mg/L), and total nitrogen compounds, such as TKN (52 mg/L). The pH of the discharge water was neutral (7-8). As with the synthetic column system, wastewater passed up through a 600 ml column filled with 150 ml of granular media (Example 3). The initial flow through the column was set at a 60 minute EBCT. This test (Sample 5043) resulted in a drop in Phosphorous from an average influent content of 6.5 mg/L to less than 1 mg/L PO₄—P after 1200 bed volumes as shown in FIG. 11.

### EXAMPLE 13

### Alternate Approach to Prepare Simple Shapes

An alternative approach can be used to prepare a porous monolith, other than foaming, as described previously. In this approach, granules of a nano-iron modified media were bound together with an alumino-silicate binder in a mold using pressure to make a consolidated part. Granular media used was prepared as that described in Example 4. These granules were mixed with a small amount of alumino-silicate binder similar to that described in Example 1 and then placed in a mold/die and pressure applied, until chemical reactions hardened the binder. Disks were made having a 2.25-inch diameter at different pressures and evaluated for water flow through the disk until a satisfactory flow rate was found. These disks had a higher density than those made using the procedures described in Example 1 and represent an alternative way of preparing composite media and could be used for making media of different sizes and permeability.

### EXAMPLE 14

### Alternative Porous Substrate—Metakaolin

While the porous ceramic described in Example 1 is the preferred substrate for preparing the Phosphorous media because of its high surface area and flexibility of preparing different shapes, the methods for preparing nanomaterials described in Examples 2 and 3 can be used with other porous substrates. One such substrate investigated was a porous metakaolin, which initially had surface area of 25 m²/g. Using the method described in Example 3, the metakaolin was first treated with an oxidizing agent such as potassium permanganate for few hours and then reacted with an iron precursor solution to form nano-iron oxyhydroxide or iron oxide on the surface of the base porous media. After the modification is completed, the media was dried and characterized for surface area (BET). The addition of nano-materials provided a modest increase in the surface area (28 m²/gram). The metakaolin media was tested for Phosphorous removal (standard 24 hour batch test) and was found to remove 25-30 mg of Phosphorous per gram per of media.

### EXAMPLE 15

### Alternative Porous Substrate—Zeolite

A naturally occurring porous Zeolite material was also evaluated. The Zeolite had surface area of 10 m²/gram. It was modified with nanomaterials in the same manner similar as metakaolin (Example 14). Nano-modification increased the surface area of the media to 14 m²/gram. The nano-modified zeolite material was tested for Phosphorous removal (standard 24 hour batch test) and showed a capacity of 11-15 mg of Phosphorous per gram of media.

While the process and materials have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

### REFERENCE

Safferman, S. I. et. al. “Chemical Phosphorous Removal from Onsite Generated Wastewater.” Proc., Water Environment Federation Annual Conference, (2007) San Diego Calif.

We claim:

1. A composite porous inorganic filtration media that provides a high capacity for removal of Phosphorous and Phosphorous containing compounds from contaminated water, which comprises:
reactive alumina/silica particles characterized by interconnected hierarchical porosity, high available surface area, and pore morphology supporting active nano-materials.

2. The composite porous filtration media of claim 1, wherein said active nano-materials contain one or more of Iron (Fe), Magnesium (Mg), Lanthanum (La), Calcium (Ca), Zirconia (Zr), or compounds containing these elements, said nanomaterials being less than about 700 nm in size.

3. The composite porous filtration media of claim 1, wherein said reactive alumina/silica materials contain are one or more of sodium, potassium, lithium silicate, lithium aluminate, clays, or silica.

4. The composite porous filtration media of claim 1, formed from the following combined ingredients: between about 2% and 10% sodium silicate, between about 2% and 10% sodium aluminate, between about 10% and 25% water, between about 0.1% and 2% surfactants, between about 5% and 30% reactive alumina/silica, between about 5% and 70% Iron based constituents, between 0 to 10% enhancing constituents, and between about 0.02% and about 1.0% gassing agent.

5. The composite porous filtration media of claim 4, which also contains iron based constituents being one or more of metallic iron, steel, steel alloys, iron oxide, or iron hydroxide.

6. The composite porous filtration media of claim 4, which also comprises enhancing constituents being one or more of Calcium (Ca), Magnesium (Mg), Lanthanum (La), Zirconium (Zr) or compounds containing one or more of said elements.

7. A method for making a composite inorganic porous filtration media for treatment of water to remove phosphates, which comprise the steps of:
(a) providing (1) a slurry containing a soluble silica source, an iron-based constituent, a reactive alumina/silica source, surfactants, and a gassing agent; and (2) a slurry containing a source of soluble alumina, reactive alumina/silica compounds, and an iron-based constituent, and surfactants;
(b) maintaining said slurries at, above, or below about room temperature;
(c) blending said slurries in a controlled manner to prepare a uniform dispersion of all ingredients in the slurries;
(d) molding the blend of said two slurries; and
(e) providing sufficient time to elapse of the molded slurries to permit the gassing agents in combination with the surfactants to produce gas in order to create the desired porous filtration media before the molded part hardens.

8. The method of claim 7 wherein said blend of said two slurries is molded in the presence of metal or polymeric reinforcement.

9. The method of claim 7, additionally comprising growing active nanoscale material at the surface of the porous filtration media by functionalizing the porous surfaces with a base and then treating with a solution of metallic salts.

10. The method of claim 9, wherein the base is one or more of tetra methyl ammonium hydroxide, sodium hydroxide, ammonium hydroxide, potassium hydroxide, or lithium hydroxide.

11. The method of claim 9, wherein the metallic salts are one or more of iron sulfate, iron nitrate, iron chloride, iron acetate, or iron oxalate.

12. The method of claim 7, additionally comprising growing active nanoscale material at the surface of the porous filtration media by functionalizing the surface with an oxidizing agent and then treating with solution of metallic salts.

13. The method of claim 12, wherein a base is the oxidizing agent and is one or more of potassium permanganate, hydrogen peroxide, or benzyl peroxide..

14. The method of claim 12, wherein the metallic salts are one or more of iron sulfate, iron nitrate, iron chloride, iron acetate, or iron oxalate.

15. The method of claim 7, wherein the surface of the hardened molded part is treated with a cationic surfactant being one or more quaternary ammonium salt, such as, hexadecyl trimethyl ammonium bromide, dodecyl trimethyl ammonium bromide, octadecyl trimethyl ammonium bromide, hexadecyl trimethyl ammonium chloride, dodecyl trimethyl ammonium chloride, octadecyl trimethyl ammonium chloride, myristyl trimethyl ammonium bromide, or myristyl trimethyl ammonium chloride.

16. A method for removing Phosphorous from a water source contaminated with Phosphorous, which comprises contacting said Phosphorous -contaminated water source with a composite porous inorganic filtration media comprising reactive alumina/silica particles characterized by interconnected hierarchical porosity, high available surface area, and pore morphology supporting active nano-materials.

17. The method of claim 16, wherein wherein said active nano-materials contain one or more of Iron (Fe), Magnesium (Mg), Lanthanum (La), Calcium (Ca), Zirconia (Zr), or compounds containing these elements, said nanomaterials being less than about 700 nm in size.

18. The method of claim 16, wherein said reactive alumina/silica materials contain are one or more of sodium, potassium, lithium silicate, lithium aluminate, clays, or silica.

19. The method of claim 16, wherein said composite porous inorganic filtration media is formed from the following combined ingredients: between about 2% and 10% sodium silicate, between about 2% and 10% sodium aluminate, between about 10% and 25% water, between about 0.1% and 2% surfactants, between about 5% and 30% reactive alumina/silica, between about 5% and 70% Iron based constituents, between 0 to 10% enhancing constituents, and between about 0.02% and about 1.0% gassing agent.

20. The method of claim 16, wherein the Phosphorous removed by said composite porous inorganic filtration media is removed by treating with a base; and said base-treated composite porous inorganic filtration media is regenerated with mild acid.
